(19) United States
(12) Patent Application Publication
(10) Pub. No.: US 2026/0296646 A1
(43) Pub. Date: Oct. 1, 2026

(54) Installation Of Passenger Seats

(71) Applicant: Airbus Operations GmbH, Hamburg (DE)

(72) Inventor: Tobias-Valentin Mayer, Hamburg (DE)

(73) Assignee: Airbus Operations GmbH, Hamburg (DE)

(21) Appl. No.: 19/574,614

(22) Filed: Mar. 23, 2026

(30) Foreign Application Priority Data
Mar. 27, 2025 (DE) 102025001076.1

(51) Int. Cl. B64D 11/06

(52) U.S. Cl. CPC B64D 11/0601

(57) ABSTRACT

An installation of passenger seats onboard a passenger airplane is described. In order to provide further improved seating layouts, a cabin cross-section of a commercial aircraft is described. The cross-section includes a first lateral seating zone, a central seating zone, a second lateral seating zone, a first aisle between the first lateral seating zone and the central seating zone and a second aisle between the second lateral seating zone and the central seating zone. The first lateral seating zone includes a single seat per seat row, and the second lateral seating zone also comprises a single seat per seat row.

### CROSS REFERENCE TO RELATED APPLICATIONS

The present application claims priority from German Application No. 102025001076.1 filed Mar. 27, 2025, the disclosure of which is hereby incorporated herein by reference.

### FIELD OF THE INVENTION

The present invention relates to installation of passenger seats onboard a passenger airplane; the present invention relates in particular to a cabin cross-section of a commercial aircraft, to an aircraft cabin of a commercial aircraft, to an aircraft for passenger transport and to a method for preparing a passenger cabin on board a commercial aircraft.

### BACKGROUND OF THE INVENTION

In a commercial aircraft, passenger seats are distributed within the cabin space to accommodate passengers during flight. A common concept is to provide several seats in rows that are arranged perpendicular to a flight direction. For safety and comfort, a longitudinal space forming a “corridor” is usually arranged to provide access to each seat row. In aircrafts, the corridor is called aisle. To reach a seat within the row that is one or two seats further away from the aisle, a passenger has to “climb” past the respective seats. Besides seats, also stowage compartments are provided for onboard luggage and other passenger belongings. A primary criteria for the seating layout is the efficient use of the space available within the fuselage. However, it has been shown that an increasing need for better efficiency exists.

### SUMMARY OF THE INVENTION

There may thus be a need to provide further improved seating layouts. The object of the present invention is solved by the subject-matter of the independent claims; further embodiments are incorporated in the dependent claims. It should be noted that the following described aspects of the invention apply also for the cabin cross-section of a commercial aircraft, for the aircraft cabin of a commercial aircraft, for the aircraft for passenger transport and for the method for preparing a passenger cabin on board a commercial aircraft.

According to the present invention, a cabin cross-section of a commercial aircraft is provided. The cross-section comprises a first lateral seating zone, a central seating zone, a second lateral seating zone, a first aisle between the first lateral seating zone and the central seating zone and a second aisle between the second lateral seating zone and the central seating zone. The first lateral seating zone comprises a single seat per seat row, and the second lateral seating zone also comprises a single seat per seat row.

As an effect, access to the respective seats is improved even though two aisles are provided, which may have a minimum width. In each aisle, two seats are directly accessible from the aisle. As a result, four seats in total (per row) are directly accessible from an aisle. When, for example, arranging four seats in the central seating zone, for accessing one of the two seats between the aisle seats, a user only has to pass a single seat. This improved accessibility means shorter embarking and disembarking times. And shorter boarding and off-boarding times mean a more efficient use of a commercial aircraft.

As a further technical effect, two aisles allow larger aircraft doors which provides advantages regarding the entry and exit speed and the number of passengers.

As a further effect, the arrangement of two aisles does not need free headspace in the central zone, but only along the lateral parts of the cabin near the cured sidewall sections. Thus, space along the center of the cabin can be used to a maximum extent for stowage purposes, like storing luggage, clothes and other belongings. In case of a central aisle, the space above the area required as user’s free headspace cannot be used for stowage purposes. In case of two lateral aisles, there is no, or at least only minimal, amount of un-used space in the upper space inside the cabin.

As an advantage, several different configurations are possible, such as a so-called 1-4-1 seating configuration, or a 1-3-1 seating configuration, or even a 1-2-1 seating configuration. While seat configurations and pitch may vary, even different pitch in the lateral seats column than the pitch in the central seating zone, overhead storage compartments (OHSC) may remain and make maximum use of available space, also in combinations with monuments such as lavatories and galleys. The present twin aisle concept is capable of targeting a smaller size cabin towards a 200+ passengers capacity.

According to an example, the first aisle and the second aisle each provide a free standing height of approximately 1850 mm (72.8 inches) in an area next to the respective lateral seating zone. In an option, the free standing height is provided along the aisle across a width of at least approximately 500 mm (20 inches).

An advantageous effect is that space is used in an efficient manner. The lateral seat is provided next to the inner side of the curved outer wall, i.e. the window section, where standing height is limited due to the curvature. The aisle area, where standing height is required, is moved as close as possible to the outer wall.

It is noted that all figures for dimensions are approximate figures. The term “approximate” includes deviations of +/- 5%, or +/- 10% or of even +/- 15%.

According to an example, the first aisle and the second aisle each define a footprint of a space-envelope extending vertically from a floor area of the first aisle and the second aisle. The space-envelope has a height of approximately 1850 mm (72.8 inches) and virtually touches an inner cabin lining on one of its lateral upper edges.

The space-envelope is designed in view of a 95 percentile US male passenger. According to an example, an area above the first lateral seating zone is free of a stowage-zone. An area above the second lateral seating zone is also free of a stowage-zone.

This allows to move the aisles towards the respective lateral wall sections and to gain as much space as possible in the central area which can be used for stowage arrangements or for monuments.

As another effect, the cabin space appears wider and more open as compared to a single aisle configuration.

According to an example, a central stowage zone is arranged in an area above the central seating zone. In an option, overhead stowage compartments are provided at least along a part of the central stowage zone.

As an effect, a maximum capacity for storing personal belongings and luggage on board the aircraft is achieved.

According to an example, the cabin cross-section further comprises a cabin lining having a first curved lateral part and a second curved lateral part, both connected via an upper ceiling part. A central area of the upper ceiling part comprises a central interface for i) mounting central overhead bins, and/or for ii) connecting upper portions of monuments.

As an effect, an integration of monuments like stowage compartments, class dividers or lavatories is facilitated, since the necessary interfaces for load introduction can be integrated in the central ceiling portion in a similar way as connection interfaces for attaching stowage compartments.

Monuments can thus be mounted in a facilitated manner. The lateral side wall portions of the cabin have a facilitated structure, since load bearing connectors are not required due to shifting the overhead bins into the central zone above the central seating area.

According to an example, the cabin lining comprises a first passenger supply unit above the first lateral seating zone, and a second passenger supply unit above the second lateral seating zone.

The term “passenger supply unit” relates to service installation for supplying energy, data signals and oxygen including oxygen masks to the passenger or crew member.

This ensures the required supply in terms of safety and comfort.

According to an example, a first light rail is arranged above the first lateral seating zone, and a second light rail is arranged above the second lateral seating zone. In an option, a first handrail is arranged above the first lateral seating zone and a second handrail is arranged above the second lateral seating zone.

The term “light rail” relates to an elongate structure like a rail that also provides light. The term “handrail” relates to an elongate structure like a rail that forms a handrail.

The light rail provides cabin light and can be part of the cabin lining structure. The handrail provides support for a passenger walking along the aisle.

This configuration provides a maximum number of seats within e.g. a narrowbody aircraft while offering maximum user comfort in terms of accessibility.

According to the present invention, also an aircraft cabin of a commercial aircraft is provided. The cabin comprises at least one passenger seating area with a plurality of rows of passenger seats on a cabin floor. At least a part of the at least one passenger seating area comprises a cross-section according to one of the preceding examples.

According to an example, the aircraft cabin further comprises a cabin lining with first and second lateral sidewall sections on both sides of an elongate cabin space and upper ceiling sections between the first and the second lateral sidewall sections, the lateral sidewall sections and the upper ceiling section enclosing the cabin space. At least a part of the first and second lateral sidewall sections forms a transition from a sidewall cabin lining portion adjacent the seats of the first and second lateral seating zones towards a ceiling cabin lining portion.

According to the present invention, also an aircraft for passenger transport is provided. The aircraft comprises a fuselage structure and a cabin accommodated within the fuselage structure. The cabin comprises a cross-section according to one of the preceding examples at least along a part of the cabin.

As indicated above, as an advantage, increased qualities for seating configurations with same floor to floor lining are provided. This also results in an easier reconfiguration due to the center monument. It also means less parts.

Benefits are accessibility and also the value of a “single & aisle seat”, i.e. a seat that does not have direct adjacent neighboring seats in the economy class and that is arranged next to an aisle. Further, also better service and boarding-deboarding times can be achieved.

Besides the technical advantages, the innovative concept can also result in increased revenue generation due to finer segmentation opportunities. Customization concentrated to center monuments without intruding into floor to floor lining supports late customization at industrial level same as reconfiguration, e.g. seat pitch adaptation or change in monument capacity.

According to an example, in the part of the cabin, window seats are having cabin wall segments with windows on their outer lateral side and one of the two aisles on their inner lateral side.

According to an example, the aircraft has a small-body cross-section with a diameter of maximum 3935 to 4217 mm (155 to 166 inches) when measured from an armrest facing the side wall lining to the other armrest of the other seat facing the opposite side wall lining. In an option, the aircraft is a short-range aircraft.

According to the present invention, a method for preparing a passenger cabin on board a commercial aircraft is provided. The method comprising the following steps:

Arranging a first lateral seating zone with a single seat per seat row;

Arranging a central seating zone with a plurality of seats per row; and

Arranging a second lateral seating zone with a single seat per seat row;

A first aisle is formed between the first lateral seating zone and the central seating zone, and a second aisle is formed between the second lateral seating zone and the central seating zone.

According to an aspect, a floor to floor cabin design is provided with new aisle positions based on a twin aisle concept including optional monuments in a center section. The outer seats are arranged as single seats having the outer wall on one side and the aisle on their other side. The space above these single seats is kept free of stowage compartments. The outer wall provides a basically continuously curved enclosure of the cabin space which curve basically follows the round shape of the fuselage such that the side wall portion gradually transitions or merges into the upper ceiling of the cabin.

According to an aspect, the outer wall is provided as a curved concave wall contour that continuously extents from the window section until at least a passenger’s head when standing in one of the two aisles next to the single window seats.

In an option, the curved wall contour is only interrupted by a functional unit in which passenger service functions such as the passenger supply unit or light and air supply are integrated. The functional unit may also provide a crew communication interface with e.g. a flight attendant button or a display component with a fasten-seat-belt indicator.

According to an aspect, a cabin layout is provided for narrowbody aircrafts in which overhead stowage compartments are arranged within the central portion of the cabin’s cross-section and in which the lateral outer cabin walls with the windows are kept free of such overhead stowage compartments. The narrowbody aircraft’s diameter is such that a maximum number of six economy class passenger seats can be arranged per row. However, instead of a single aisle, two aisles are provided. Furthermore, the aisles are moved laterally outwards such that only one seat is arranged between the aisle and the outer wall.

In an option, the economy class passenger seats have a width between approximately 400 and 500 mm. In example, a width in a range of approximately 430 to 470 is provided. In another example, the economy class passenger seats have a width of 430 to 440 mm.

In the present context, the term „narrow-body aircraft“ is used for an aircraft having a maximum cabin diameter, e.g. permitting up to 6-abreast seating in the cabin. For example, the cabin is less than approximately 4 m (4000 mm; or 13 feet) in width. In an example, the width is less than 5 m (5000 mm; or 16 ft). The term „narrow-body aircraft“ is used independent of the number of aisles. It is noted that the present solution provides a dual-aisle or twin-aisle cabin layout in a narrow-body aircraft.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 schematically shows an example of a cabin cross-section with two lateral aisles for a narrowbody commercial aircraft.

FIG. 2 schematically shows an example of an aircraft cabin for a narrowbody commercial aircraft in a cross-section.

FIG. 3 schematically shows another example of an aircraft cabin.

FIG. 4 shows a perspective view of a single seat column in a lateral zone of the cabin.

FIG. 5a shows a cross sectional view of one of the lateral aisles with a lateral seat, accommodated by a 95 percentile US female passenger.

FIG. 5b shows a cross sectional view of one of the lateral aisles with a lateral seat, accommodated by a 95 percentile US male passenger.

FIG. 6 shows another example of an aircraft cabin for a narrowbody commercial aircraft in a cross-section with a 1-4-1 seat configuration and central overhead stowage compartments.

FIG. 7 shows a further example of an aircraft cabin in a cross-section.

FIG. 8 shows a plan view of an example of the aircraft cabin.

FIG. 9 shows a cross-section of a narrowbody commercial aircraft.

FIG. 10 shows basic steps of an example of a method for preparing a passenger cabin on board a commercial aircraft.

### DETAILED DESCRIPTION OF EMBODIMENTS

Certain embodiments will now be described in greater details with reference to the accompanying drawings. In the following description, like drawing reference numerals are used for like elements, even in different drawings. The matters defined in the description, such as detailed construction and elements, are provided to assist in a comprehensive understanding of the exemplary embodiments. Also, well-known functions or constructions are not described in detail since they would obscure the embodiments with unnecessary detail. Moreover, expressions such as “at least one of”, when preceding a list of elements, modify the entire list of elements and do not modify the individual elements of the list.

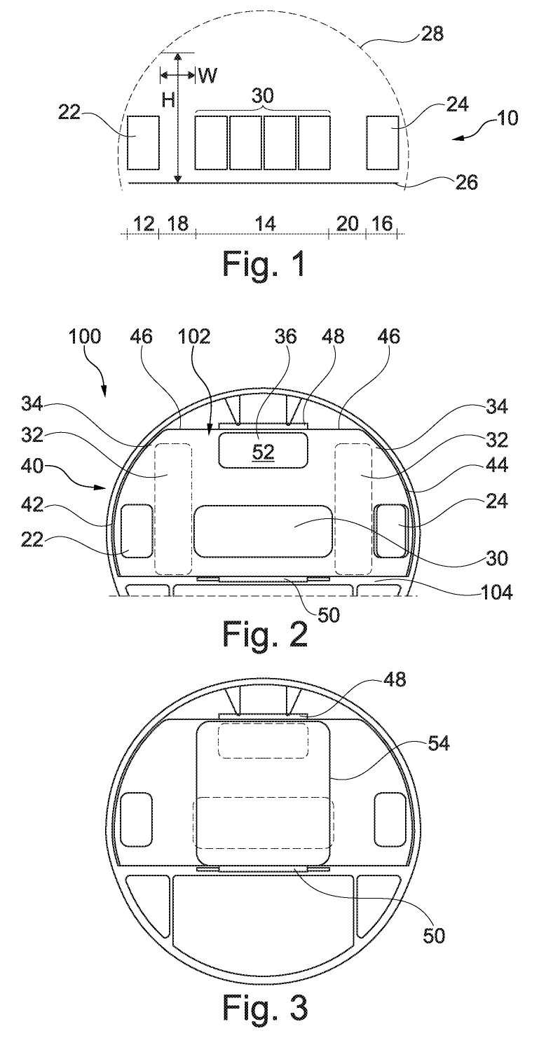

FIG. 1 schematically shows an example of a cabin cross-section 10 with two lateral aisles for a narrowbody commercial aircraft. The cross-section 10 comprises a first lateral seating zone 12, a central seating zone 14, a second lateral seating zone 16, a first aisle 18 between the first lateral seating zone 12 and the central seating zone 14, and a second aisle 20 between the second lateral seating zone 16 and the central seating zone 14. The first lateral seating zone 12 comprises a first single seat 22 per seat row, and the second lateral seating zone 16 comprises a second single seat 24 per seat row as well.

In FIG. 1, a bracket indicates that the central seating zone 14 comprises a central seating arrangement 30.

According to an example, the central seating zone 14 comprises four passenger seats per seat row.

Thus, a 1-4-1 configuration is provided.

The term “cabin cross section” relates to constructional setup of a layout of a part of the aircraft cabin. The cabin cross section 10 defines the arrangement of passenger seat structures in relation to aisle structures. The cabin cross section 10 defines the arrangement also in relation to enclosing structures of the fuselage such as side wall portions and ceiling portions of the fuselage.

In a first example, the cabin cross section 10 is applied throughout the complete aircraft cabin. In a second example, the cabin cross section 10 is applied within a part of the aircraft cabin; the other part or other parts of the aircraft cabin may have different cross-sections.

In FIG. 1, a first line 26 indicates a cabin floor. For a better understanding, a broken line arch 28 indicates a cabin lining forming the cabin space of a cabin for which the cabin cross section 10 is provided.

In an option, the cross-section 10 belongs to a small-body cross-section aircraft. In an example, the small-body cross-section aircraft is a narrowbody aircraft.

The cabin cross-section 10 has a diameter of maximum 3935 mm to 4217 mm (155 to 166 inches) when measured from an armrest facing a side wall lining on one lateral side of the fuselage to the other armrest of the other seat facing the opposite side wall lining on the other lateral side of the fuselage.

In an option, a narrowbody aircraft is provided with a fuselage armrest up to armrest width between 3935 mm (155 inches) and 4699 mm (185 inches).

The term “lateral seating zone” relates to a portion of the cabin used for arranging seats, which portion is on the side of the cabin, when viewed in a direction of travel or in an extension direction of the cabin. The lateral seating zones 12, 16 can also be referred to as side seating zones, window seating zones or outer seating zones.

The term “central seating zone” relates to a portion of the cabin used for arranging seats, which portion is in the middle or center of the cabin, when viewed in a direction of travel or in an extension direction of the cabin. The central seating zone 14 can also be referred to as middle seating zone, main seating zone or inner seating zone.

The term “aisle” relates to a space between the seats that usually runs in the direction of travel or in the extension direction of the cabin. The aisle is a free space that can be used for passenger and crew movements as well as movement of onboard serving services like trolleys. The aisle forms e.g. a linear extending movement corridor.

The single seat 22 of the first lateral seating zone 12 can also be referred to as first lateral seat. The single seat 24 of the second lateral seating zone 16 can also be referred to as second lateral seat.

The single seats are each arranged adjacent the respective aisle.

The first aisle 18 can also be referred to as first lateral aisle, and the second aisle 20 can also be referred to as second lateral aisle. A central aisle is not provided. The cabin cross-section 10 is center-aisle free. The cabin cross-section 10 rather provides a twin aisle configuration.

The cabin cross-section 10 of the commercial aircraft comprises the seating zones and aisles arranged across a cabin floor.

The commercial aircraft can also be referred to as passenger aircraft.

The cabin cross-section 10 is a two-aisle layout of the cabin, even for smaller aircrafts.

The two aisles 18, 20 consume more space than one aisle, but advantages are provided in that an improved adaptability concerning changes in the seat pitch is made possible. Another advantage is the accessibility of the seats. In the provided two-aisles concept, a passenger never has to “crawl over” more than one seat when trying to reach his/her seat from the aisle.

The single lateral seats 22, 24 with aisle access avoid for example "excuse me" or even "double excuse me" seats. Similar avoidance of "double excuse me" seats is the case for the center seats, where only one other passenger seat is involved when entering the seat.

In an option of the cabin cross-section 10, the central seating zone 14 comprises four passenger seats per seat row.

In another example, the central seating zone 14 comprises three passenger seats per seat row. In a further example, the central seating zone 14 comprises two passenger seats per seat row.

In an option of the cabin cross-section 10, the first aisle 18 and the second aisle 20 each provide a free standing height H of approximately 1850 mm (72,8 inches) in an area next to the respective lateral seating zone 12, 16.

In an option, the free standing height H is provided along each of the aisles 18, 20 across a width W of at least approximately 500 mm (20 inches).

The term “free standing height” relates to a space which does not comprise any obstacles and which can thus be used for standing and moving within this space, while standing upright.

The free standing height H is provided by a virtual envelope or box enclosing an empty space, i.e. a space without any passenger seat parts, stowage bin parts or cabin lining parts. The free standing height H in the first aisle 18 and the second aisle 20 is provided for a 95 percentile male US passenger/user.

The term “width” relates to a dimension across the aisle, i.e. a dimension transverse to the longitudinal direction.

FIG. 2 schematically shows an example of an aircraft cabin 100 for a narrowbody commercial aircraft in a cross-section. The aircraft cabin 100 comprises at least one passenger seating area 102 with a plurality of rows (only one is shown in FIG. 2) of passenger seats on a cabin floor 104. At least a part of the at least one passenger seating area comprises an example of the cross-section 10 according to the preceding and following examples.

It is noted that further details and options of the cabin cross-section 10 are explained in the following, also referring to the drawings showing examples of the aircraft cabin 100.

In an option of the cabin cross-section 10, the first aisle 18 and the second aisle 20 each define a footprint of a space-envelope 32 extending vertically from a floor area of the first aisle 18 and the second aisle 20. The space-envelope 32 has a height of approximately 1850 mm and virtually touches an inner cabin lining 34 on one of its lateral upper edge, i.e. corner.

The term “footprint” relates to a projection downwards on the cabin floor.

The term “space-envelope” relates to a virtual shell or frame enclosing the space provided for passenger and staff movement.

The term “touches” relates to an adjacent arrangement, i.e. where both come close to each other.

The space envelope 32 provides and defines the required aisle clearance.

The aisle area volume provided for passengers moving along the aisle onboard the aircraft touches the inner lining of the curved cabin outer wall segment with its upper volume edge.

The curved cabin segments form a ceiling panel in the area above the first aisle and the second aisle.

In an option of the cabin cross-section 10, an area above the first lateral seating zone 12 is free of a stowage-zone. Further, also an area above the second lateral seating zone 16 is free of a stowage-zone.

The term “free of a stowage-zone” relates to providing these space portions as empty and unoccupied cabin space.

In an option of the cabin cross-section 10, a central stowage zone 36 is arranged in an area above the central seating zone 14.

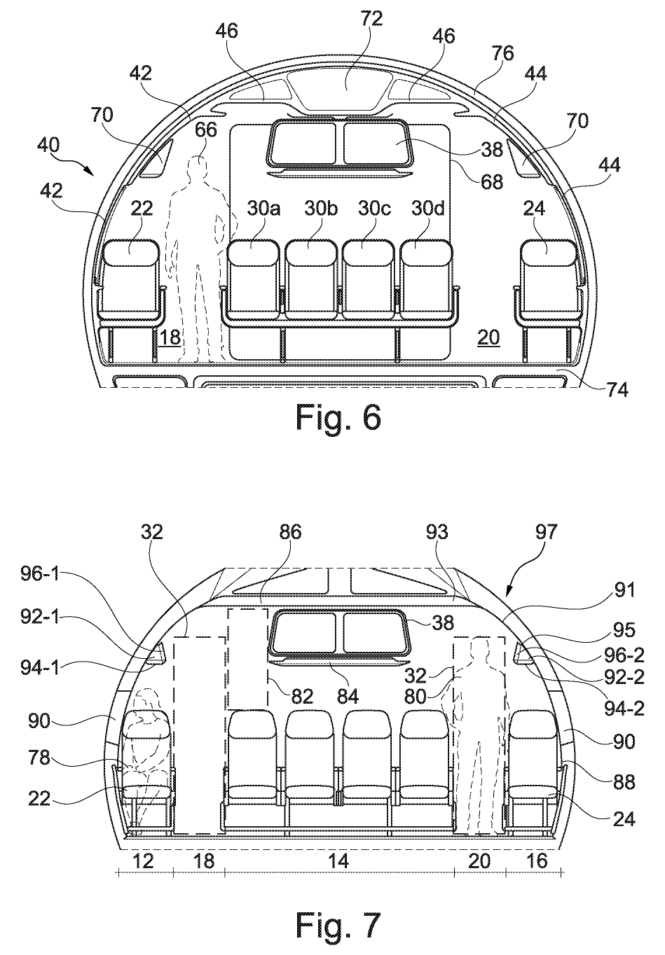

In an option, shown in FIG. 6, overhead stowage compartments 38 are provided at least along a part of the central stowage zone 36.

The term “central stowage zone” relates to stowage compartments in a center zone of the cabin, referring to a center line in travel direction of the aircraft.

In an example, one large double center overhead storage compartment is provided (see FIG. 6).

An option of the cabin cross-section 10 (also indicated in FIG. 6) is further comprising a cabin lining 40 having a first curved lateral part 42 and a second curved lateral part 44, both connected via an upper ceiling part 46. A central area of the upper ceiling part comprises a central interface 48. The central interface 48 is configured for one or both of the group comprising i) mounting central overhead bins, and ii) connecting upper portions of monuments.

The central interface 48 in the ceiling provides an upper central interface.

A further central interface 50 is provided as a lower central interface in the floor area where the central seating zone 14 is provided.

The central interface arrangement with the upper central interface 48 and the lower further central interface 50 provide flexibility for the cabin layout, as it allows the fixation of different items like the seats or monuments.

In FIG. 2, a stowage container 52 of the central stowage zone 36 is connected to the upper central interface 48. Further, the central seating arrangement 30 is connected to the lower further central interface 50.

FIG. 3 schematically shows another example of the aircraft cabin 100. In FIG. 3, a monument 54 is connected to the upper central interface 48 and the lower further central interface 50. The central seating arrangement 30 and the stowage container 52 are indicated with broken lines to illustrate the variety of mounting options provided by the central interface arrangement.

The cabin lining parts can also be referred to as cabin lining portions, since they can be provided in an integrated manner, or connection of panels or segments may be provided within the curved lateral parts or within the ceiling part.

The term “curved lateral part” relates to portions of the cabin lining in the area of the sidewall sections, i.e. to the side, which portions have a curved shape to follow the contour of the fuselage.

The term “upper ceiling part” relates to portions of the cabin lining in the center area, i.e. above the center seating part.

The upper ceiling part is an upper curved ceiling part.

The central interface provides a support structure.

In an option, one large square revenue space allocation is provided for various customization and configuration opportunities in the center without interfering with the lining.

As an example, in the central seating zone, also a 2032 mm (80 inches) wide center monument for six trolleys is provided.

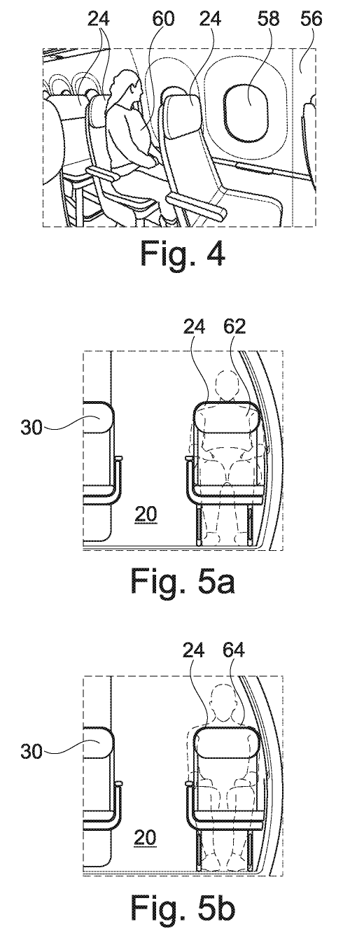

FIG. 4 shows a perspective view of a row of single seats, for example the single seats 24 of the second lateral seating zone 16 next to a sidewall 56 of the cabin comprising a plurality of windows 58. A passenger 60 is sitting in one the seats. The passenger is having the second aisle on his/her one lateral side and the sidewall 56 with a window on his/her other lateral side. A panel of the sidewall is curved and starts forming a ceiling panel above the head of the passenger 60.

FIG. 5a shows a cross sectional view of one of the lateral aisles, for example the second aisle 20, with a lateral seat, for example the single seat 24 of the second lateral seating zone 16, accommodated by a 95 percentile US female passenger 62.

FIG. 5b shows another cross sectional view of the second aisle 20, with the single seat 24 of the second lateral seating zone 16, accommodated by a 95 percentile US male passenger 64.

FIG. 6 shows another example of the aircraft cabin 100 for a narrowbody commercial aircraft in a cross-section with a 1-4-1 seat configuration and central overhead stowage compartments. The central seating arrangement 30 is shown with seats 30a, 30b, 30c and 30d. A first passenger 66 is shown in the first aisle 18. A frame 68 indicates the option of a monument in the central seating zone 14.

As an option, the space above the lateral single seats, i.e. the first single seat 22 and the second single seat 24 is stowage-free. However, a relatively small functional arrangement 70 can be provided, for example for providing supply and service functions, e.g. for a passenger seat light, accommodating passenger supply units with e.g. oxygen masks, for air outlets and for flight attend call buttons.

A crown area 72 above the overhead stowage compartments can be used for accommodating onboard infrastructure and equipment.

Further, a cabin floor 74 is shown in a simplified manner. Furthermore, a fuselage 76 is also indicated.

FIG. 7 shows a further example of the aircraft cabin 100 in a cross-section. The cross-section comprises two outer lateral single seats, i.e. the first single seat 22 of the first lateral seating zone 12 and the second single seat 24 of the second lateral seating zone 16, plus four central seats of the central seating zone 14. A first passenger 78 is shown in the first single seat 22; a second passenger 80 is shown standing in the second aisle 20.

The space-envelope 32 is indicated with broken lines in both the first aisle 18 and the second aisle 20.

In an option, shown in FIG. 7, a further free space 82 is provided over a part of the passenger seats adjacent the first aisle 18 and the second aisle 20 on their respective inner sides, i.e. above the outer seats of the center seating zone 14. The further free space 82 reaches from an upper edge of the seat back rest towards a ceiling lining. The further free space 82 is stowage-less, i.e. there is no stowage compartment in this space.

The further free space 82 can be provided on one side of the central seating zone 14 (as indicated) or also on both sides (as shown).

As an option, a passenger supply unit arrangement 84 is provided below the overhead stowage compartments 38.

A ceiling portion 86 of the lining can be provided for lighting of the cabin. The cabin comprises a lateral sidewall portion 88 on either side with a window 90.

In an option of the cabin cross-section 10, the cabin lining comprises a first passenger supply unit 92-1 above the first lateral seating zone 12, and a second passenger supply unit 92-2 above the second lateral seating zone 16.

In another option of the cabin cross-section 10, a first light rail 94-1 is arranged above the first lateral seating zone 12, and a second light rail 94-2 is arranged above the second lateral seating zone 16.

In a further option, a first handrail 96-1 is arranged above the first lateral seating zone 12, and a second handrail 96-2 is arranged above the second lateral seating zone 16.

In an option, the aircraft cabin further comprises a cabin lining 97 comprising first and second lateral sidewall sections 95 on both sides of an elongate cabin space and upper ceiling sections 93 between the first and the second lateral sidewall sections 95. The lateral sidewall sections 95 and the upper ceiling section 93 enclosing the cabin space. At least a part of the first and second lateral sidewall sections 95 forms a transition 91 from a sidewall cabin lining portion adjacent the seats of the first and second lateral seating zones towards a ceiling cabin lining portion.

The term “cabin lining” relates to panels provided inside the fuselage that define the cabin space.

The term “lateral sidewall sections” relates to parts of the lining on the side of the cabin.

The term “upper ceiling sections” relates to parts of the lining in an upper part.

The term “transition” relates to gradually transitioning from a lateral part to an upper part.

The ceiling cabin lining portion can also be referred to as overhead cabin lining portion.

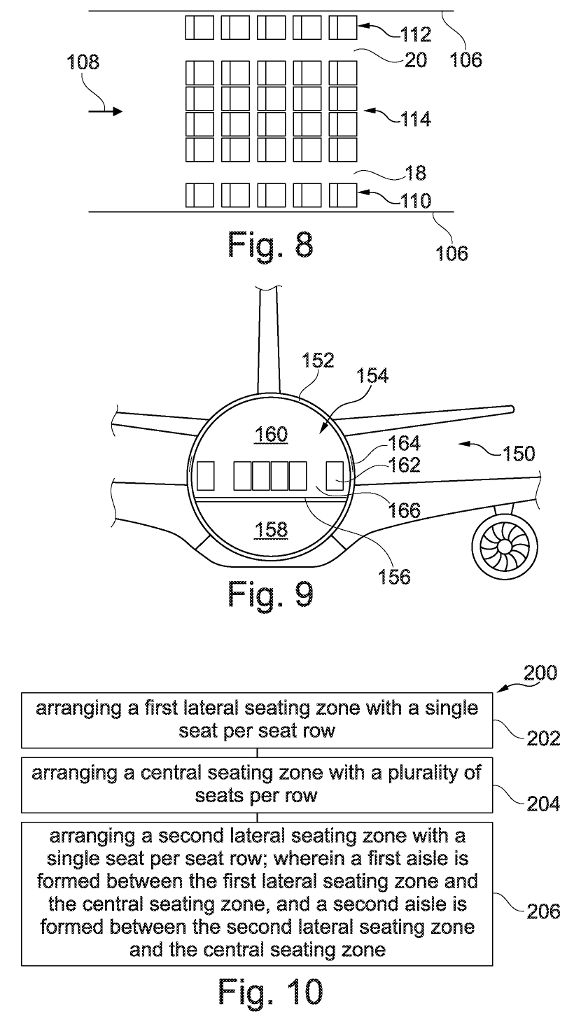

FIG. 8 shows a schematic plan view of an example of the aircraft cabin 100. Two outer lines 106 indicate the sidewalls of the cabin. An arrow 108 indicates the direction of travel of the aircraft. Seats are arranged according to the cabin cross-section 10 described above, forming rows transverse to the direction of travel, and columns in the direction of travel.

A first lateral column 110 provides the first single seats 22 of the first lateral seating zone 12. A second lateral column 112 provides the second single seats 24 of the second lateral seating zone 16. A central column 114 with four seats provides the seats of the central seating zone 14.

In addition to the passenger seats, other structures like monuments are provided, but not shown in. FIG. 8.

FIG. 9 shows a cross-section of a narrowbody commercial aircraft 150. As an example, the aircraft is an aircraft for passenger transport. The aircraft 150 for passenger transport comprises a fuselage structure 152 and a cabin 154 accommodated within the fuselage structure 152. The cabin 154 comprises an example of the cross-section 10 according to one of the preceding examples at least along a part of the cabin 154.

Thus, the cabin 154 has the cross-section 10 according to one of the preceding examples at least along a part of the cabin 154.

The space within the fuselage structure 152 is separated by a cabin floor 156 separating a lower cargo area 158 from an upper cabin space 160.

The part of the cabin that comprises the cross-section according to one of the preceding examples is provided as economy class section.

In an option of the example of FIG. 9, in the part of the cabin, window seats 162 are having cabin wall segments with windows 164 on their outer lateral side and one of the two aisles 166 on their inner lateral side.

In an option of the example of FIG. 9, the aircraft has a small-body cross-section with a diameter of maximum 3935 to 4217 mm (155 to 166 inches) when measured from an armrest facing the side wall lining to the other armrest of the other seat facing the opposite side wall lining.

The distance measured from the armrest facing the side wall lining to the other armrest of the other seat facing the opposite side wall lining can also be referred to as “usable clearance”, “clear diameter” or “inner width” of the cabin.

In another example, the cross-section is measured as outside diameter. In an option, a cross-section of a diameter of maximum 4330 mm to 4480 mm is provided as outside diameter of the aircraft’s fuselage (170 to 177 inches).

In a variation, a seat pitch of the outer, i.e. lateral single seats is arranged different to a seat pitch of seats of the central seating zone. For example, the outer seats are provided with a larger pitch.

An advantage of two aisles is also the option to provide larger aircraft doors, such as “type-A“ doors.

Thus, the twin aisle configuration in combination with two type A doors in the rear allows to further increase capacity to e.g. over 300 passengers (PAX).

In an example configuration, a type A door with a higher exit rating allows a blocked D3 exit to merge a cabin space into an undisturbed space of 25 seat rows in the rear cabin maintaining the 60 feet rule between exits to increase full pitch flexibility in that section.

Another option is the exchangeability of either outer seats or inner seats for accommodating passengers in a wheelchair.

In an example, an aisle position center can be approximately 1524 mm (60 inches) from the center to the side. Optional, an approximately 508 mm (20 inches) box for passenger clearance is virtually applied. A standing height is possible in between the maximum outboard position left to right and limited if overhead storage is installed. Of course, dimensions of the storage can vary depending on the size of the fuselage.

In an option, the aircraft 150 is a short-range aircraft.

FIG. 10 shows basic steps of an example of a method 200 for preparing a passenger cabin on board a commercial aircraft. The method 200 comprises the following steps: -

In a first step 202, a first lateral seating zone with a single seat per seat row is arranged.

In a second step 204, a central seating zone with a plurality of seats per row is arranged.

In a third step 206, a second lateral seating zone with a single seat per seat row is arranged.

A first aisle is formed between the first lateral seating zone and the central seating zone, and a second aisle is formed between the second lateral seating zone and the central seating zone.

The first step 202, the second step 204 and the third step 206 can also be provided in a different order or simultaneously.

It has to be noted that embodiments of the invention are described with reference to different subject matters. In particular, some embodiments are described with reference to method type claims whereas other embodiments are described with reference to the device type claims. However, a person skilled in the art will gather from the description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A cabin cross-section of a commercial aircraft, the cross-section comprising:
a first lateral seating zone;
a central seating zone;
a second lateral seating zone;
a first aisle between the first lateral seating zone and the central seating zone; and
a second aisle between the second lateral seating zone and the central seating zone; wherein the first lateral seating zone comprises a single seat per seat row, and the second lateral seating zone also comprises a single seat per seat row.

2. The cabin cross-section according to claim 1, wherein the first aisle and the second aisle each provides a free standing height (H) of approximately 1850 mm in an area next to the respective lateral seating zone; and
wherein the free standing height is provided along the aisle across a width (W) of at least approximately 500 mm (20 inches).

3. The cabin cross-section according to claim 1, wherein the first aisle and the second aisle each defines a footprint of a space-envelope extending vertically from a floor area of the first aisle and the second aisle; and
wherein the space-envelope has a height of approximately 1850 mm and virtually touches an inner cabin lining on one of its lateral upper edges.

4. The cabin cross-section according to claim 1,
wherein an area above the first lateral seating zone is free of a stowage-zone; and
wherein an area above the second lateral seating zone is free of a stowage-zone.

5. The cabin cross-section according to claim 1, wherein a central stowage zone is arranged in an area above the central seating zone; and
wherein overhead stowage compartments are provided at least along a part of the central stowage zone.

6. The cabin cross-section according to claim 1, further comprising a cabin lining having a first curved lateral part and a second curved lateral part, both connected via an upper ceiling part;
wherein a central area of the upper ceiling part comprises a central interface:
i) for mounting central overhead bins, and/or
ii) for connecting upper portions of monuments.

7. The cabin cross-section according to claim 1, wherein the cabin lining comprises a first passenger supply unit above the first lateral seating zone and a second passenger supply unit above the second lateral seating zone.

8. The cabin cross-section according to claim 1, wherein a first light rail is arranged above the first lateral seating zone, and a second light rail is arranged above the second lateral seating zone; and
wherein a first handrail is arranged above the first lateral seating zone and a second handrail is arranged above the second lateral seating zone.

9. The cabin cross-section according to, wherein the central seating zone comprises four passenger seats per seat row.

10. An aircraft cabin of a commercial aircraft, the cabin comprising:
at least one passenger seating area with a plurality of rows of passenger seats on a cabin floor;
wherein at least a part of the at least one passenger seating area comprises a cross-section according to claim 1.

11. The aircraft cabin according to claim 10, further comprising:
a cabin lining comprising: first and second lateral sidewall sections on both sides of an elongate cabin space and upper ceiling sections between the first and the second lateral sidewall sections, the lateral sidewall sections and the upper ceiling section enclosing the cabin space;
wherein at least a part of the first and second lateral sidewall sections forms a transition from a sidewall cabin lining portion adjacent the seats of the first and second lateral seating zones towards a ceiling cabin lining portion.

12. An aircraft for passenger transport, comprising:
a fuselage structure; and
a cabin accommodated within the fuselage structure;
wherein the cabin comprises a cross-section according to claim 1 at least along a part of the cabin.

13. The aircraft according to claim 12, wherein in the part of the cabin, window seats are having cabin wall segments with windows on their outer lateral side and one of the two aisles on their inner lateral side.

14. Aircraft according to claim 12, wherein the aircraft has a small-body cross-section with a diameter of maximum 3935 to 4217 mm (155 to 166 inches) when measured from an armrest facing the side wall lining to the other armrest of the other seat facing the opposite side wall lining; and
wherein the aircraft is a short-range aircraft.

15. A method for preparing a passenger cabin on board a commercial aircraft, the method comprising:
arranging a first lateral seating zone with a single seat per seat row;
arranging a central seating zone with a plurality of seats per row; and
arranging a second lateral seating zone with a single seat per seat row;
wherein a first aisle is formed between the first lateral seating zone and the central seating zone, and a second aisle is formed between the second lateral seating zone and the central seating zone.
